(19) United States
(12) Patent Application Publication
(10) Pub. No.: US 2024/0169236 A1
(43) Pub. Date: May 23, 2024

(54) METHOD FOR CALCULATING VC DIMENSION BOUNDARY OF QUANTUM CIRCUIT, AND PROGRAM

(71) Applicant: GRID INC., Tokyo (JP)

(72) Inventors: Masaru Sogabe, Tokyo (JP); Chih-chieh Chen, Tokyo (JP); Kodai Shiba, Tokyo (JP)

(21) Appl. No.: 18/549,728

(22) PCT Filed: Feb. 28, 2022
(86) PCT No.: PCT/JP2022/008303

§ 371 Date: Sep. 8, 2023

Related U.S. Application Data
(60) Provisional application No. 63/158,743, filed on Mar. 9, 2021.

(51) Int. Cl. G06N 10/20; G06N 10/70

(52) U.S. Cl. CPC G06N 10/20; G06N 10/70

(57) ABSTRACT

The purpose of the present invention is to provide a method for calculating a VC dimension boundary in a quantum circuit, the method comprising: a step in which a computer acquires the depth L of the quantum circuit; a step in which the computer acquires the width n of the quantum circuit; and a step in which the computer identifies the VC dimension boundary in the quantum circuit on the basis of the depth L and the width n.

### CROSS-REFERENCE TO RELATED APPLICATIONS

This application is based on U.S. Provisional Patent Application No. 63/158,743 filed on Mar. 9, 2021, which is hereby incorporated herein by reference.

### TECHNICAL FIELD

The present invention relates to a method for calculating VC dimension boundary of quantum circuit, and program.

### BACKGROUND ART

Machine learning models are expected to be applied to solve complex problems in various situations. One of the factors that hinder the increase in accuracy of conventional machine learning models is overfitting. Overfitting is a phenomenon in which, once the learning accuracy reaches a certain level, the model loses its ability to deal with unknown data thereafter, thereby causing a decline in the learning ability of the model problematically. In order to deal with this problem, restrictions are set on learning by regularization and dropout to prevent the occurrence of overfitting in the conventional machine learning models. Thus, in machine learning on classical computers, overfitting is a bottleneck in increasing the accuracy of models.

On the other hand, although it has been suggested that quantum computers have a property of suppressing overfitting due to quantum properties, no theoretical support or detailed verification has been conducted so far (for example, Non-Patent Document 1). Therefore, it has not been possible to determine the degree to which overfitting is actually suppressed in quantum circuits, and the quantum circuits could not be used as alternatives to existing machine learning models with confidence.

### CITATION LIST

### Non-Patent Document

Non-Patent Document 1: Kosuke Mitarai, Makoto Negoro, Masahiro Kitagawa, Keisuke Fujii, “Quantum Circuit Learning”, Phys. Rev. A 98 (2018) 032309, Sep. 10, 2018, http://dx.doi.org/10.1103/PhysRevA.98.032309

### SUMMARY OF INVENTION

### Technical Problem

Therefore, it is an object of the present invention to provide a means to support the fact that overfitting is unlikely to occur in quantum circuits.

### Solution to Problem

A method for calculating a VC dimension boundary in a quantum circuit according to an aspect of the present invention includes: a step in which a computer acquires a depth L of the quantum circuit; a step in which the computer acquires a width n of the quantum circuit; and a step in which the computer identifies the VC dimension boundary in the quantum circuit on the basis of the depth L and the width n.

### Advantageous Effects of Invention

The present invention provides a means to support the fact that overfitting is unlikely to occur in quantum circuits.

### BRIEF DESCRIPTION OF DRAWINGS

FIG. 1 is a diagram illustrating an example of a quantum learning circuit according to a present embodiment.

FIG. 2 is a diagram for describing light cone restrictions of a tensor network of an HEA quantum circuit according to the present embodiment.

FIG. 3 is a diagram illustrating a VC dimension boundary in a quantum circuit according to the present embodiment.

FIG. 4 is a diagram illustrating a saturation degree of a VC dimension upper bound (d*_{VC}) and a saturation degree of KL expressibility (D*_{KL}), with respect to the depth of the circuit according to the present embodiment.

FIG. 5 is a diagram illustrating the saturation degree of the VC dimension upper bound (d*_{VC}) and the saturation degree of the KL expressibility (D*_{KL}), with respect to the depth of the circuit in the case where the light cone restrictions are considered, according to the present embodiment.

FIG. 6 is a diagram illustrating the relationship between the VC dimension upper bound d*_{VC}, the KL expressibility D*_{KL}, a training error, a testing error, and a generalization error, with respect to the depth of the circuit according to the present embodiment.

FIG. 7 is a diagram illustrating a schematic configuration of an information processing device 100 that implements a quantum circuit according to an embodiment of the present invention.

### DESCRIPTION OF EMBODIMENTS

Hereinafter, the embodiments of the present invention are described in detail with reference to drawings.

### Using Quantum Circuit for Machine Learning Algorithm

Quantum circuits are used as subroutines of classical machine learning algorithms. One of the problems in classical machine learning is overfitting. One of the causes of overfitting is the complexity of a model, and in classical machine learning, overfitting is prevented by limiting the expressive power of the model through regularization or other methods. On the other hand, in quantum machine learning using quantum circuits, it has been suggested that overfitting is suppressed by quantum properties, but no theoretical support and no detailed verification have been provided so far.

In this embodiment, verification has been made on the influence of particularly the number of qubits (the width of a quantum circuit) and the number of calculation steps (the depth of the quantum circuit) on the overfitting of a general-purpose quantum circuit, which is used in many quantum algorithms. The depth of the quantum circuit corresponds to the number of layers of a neural network in classical machine learning.

As a result of the verification, when the depth of the quantum circuit is increased, it was confirmed that the expressive power of the learning model saturates at a certain value of the depth. As the expressive power of the model increases, the generalization performance decreases. In other words, the saturation of the expressive power of the model means that further increasing the circuit parameters (the depth and width of the circuit) does not further complicate the model and overfitting does not occur.

### VC Dimension of Quantum Circuit

In order to quantify the resistance of the learning model by a quantum circuit to overfitting, quantification is made in the VC (Vapnik-Chervonenkis) dimension upper bound in the quantum circuit. The VC dimension is an indicator for the complexity of the learning model and is a numerical expression of the maximum number of data into which the leaning model is able to completely classify data in a classification problem. For example, up to three points are able to be classified with a straight line in a two-dimensional space, and therefore “3” is used as the VC dimension of a linear classifier in the two-dimensional space. It is known that overfitting tends to occur when the VC dimension is large. In this embodiment, the VC dimension is calculated on the basis of the depth L and width n of the quantum circuit.

### Learning Circuit

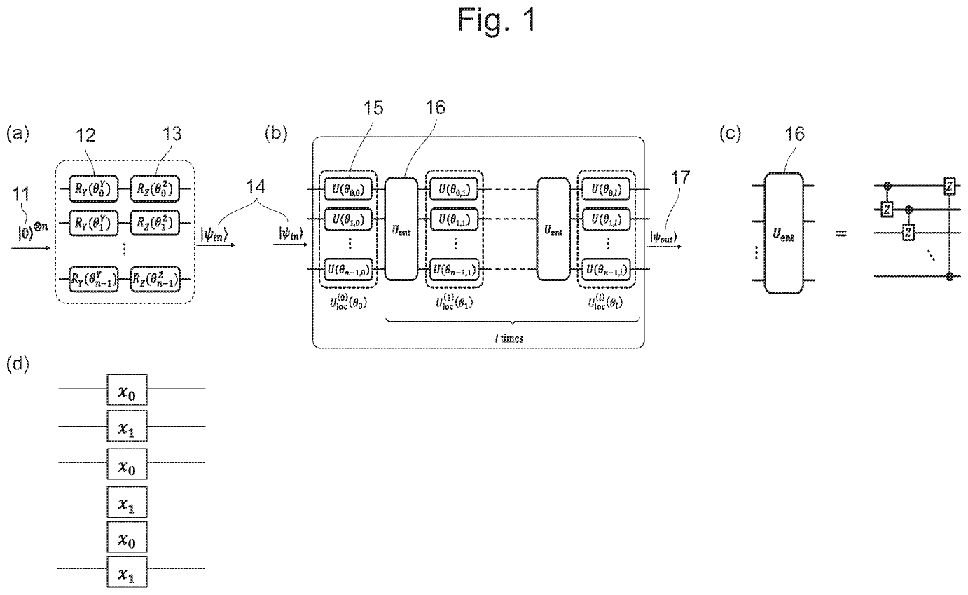

FIG. 1 is a diagram illustrating an example of a quantum learning circuit according to the present embodiment. In FIG. 1, (a) illustrates a part for encoding an input vector x, which is encoded as the rotation angle of a single qubit. Specifically, the input vector x (x∈[−1,1]^{d}) of a feature dimension d is encoded by an Ry gate (12) and an Rz gate (13) with each qubit, in one feature dimension at a time, as described in the following equation.

R₂(arccos(xᵢ²))R_{y}(arcsin(xᵢ)), [Math. 1]

If the number of qubits n is larger than the feature dimension d (for example, the number of qubits n=6, feature dimension d=2, as illustrated in FIG. 1(d)), the encoding is repeated. In this case, x_{i mod} d is encoded for the i-th qubit. Thereby, the input state ψᵢₙ(x) (14) is expressed by the following equation:

|ψᵢₙ(x [symbol] ) [symbol] =(⊗ᵢ₌₀^{d-1}R₂(ϕ_{i,in})R_{y}(θ_{i,in})|0 [symbol] )^{⊗}

[symbol]

θ_{i,in}=arcsin (xᵢ).

ϕ_{i,in}=arccos (xᵢ²)

{ϕ_{i,in}, θ_{i,in}|i=0, . . . ,d−1} [Math. 2]

In FIG. 1, (b) illustrates a learning circuit (variational circuit). The learning circuit includes a single-qubit rotation gate layer U(θ) (15) with a variational parameter θ and an unlearning entangled gate layer Uent (16), which are repeated alternately. The rotation gate layer is represented by the equation in the first line below. The variational circuit, which includes the rotation gate layer and the entangled gate layer, is able to be expressed by the equation in the second line below.

U_{loc}^{(j)}(θⱼ)=⊗ᵢ₌₀ⁿ⁻¹U(θ_{i,j})

U_{θ}=Πⱼ₌₁ [symbol] U_{loc}^{(j)}(θⱼ)UₑₙₜU_{loc}⁰⁾(θ₀) [Math. 3]

In the present embodiment, as the entangled gate Uₑₙₜ (16), there is used a hardware efficient ansatz (HEA) quantum circuit in which the two most adjacent qubits are coupled according to a periodic boundary condition (PBC), as illustrated in (c) in FIG. 1, and the entangled gate Uₑₙₜ (16) is expressed as in the following equation.

$${U}_{ent} = {\prod }_{i = 0}^{n - 1} {CZ}_{i , ( i + 1 ) modn} \qquad [ Math . 4 ]$$

Using the output state ψₒᵤₜ(x) (17) obtained by the above circuit, an expected value Z is calculated by the following equation:

[symbol]

Zᵢ(θ, \vec{x}) [symbol] =Tr(Z [symbol] U [symbol] ρᵢₙ(\vec{x})U_{θ} [symbol] )

ρᵢₙ=|ψᵢₙ(\vec{x}) [symbol] [symbol] ψᵢₙ(\vec{x})|. [Math. 5]

Using the calculated expected value Z, the following learning model is used for classification:

$$f ( \text{?} ) = {\sum }_{i = 0}^{d - 1} \text{?} ( {Z}_{i} ( \text{?} ) ) \qquad [ Math . 6 ]$$

$$\text{?} \text{indicates text missing or illegible when filed}$$

### Calculation of VC Dimension Boundary of HEA Quantum Circuit

Subsequently, a method for calculating the VC dimension boundary of the HEA quantum circuit according to the present embodiment is described. First, description is made on the VC dimension boundary for a quantum circuit whose feature space is one-dimensional and whose input part is the Ry gate only. Specifically, the VC dimension boundary is able to be calculated by a computer by performing the following calculation process (steps).

### Step 1

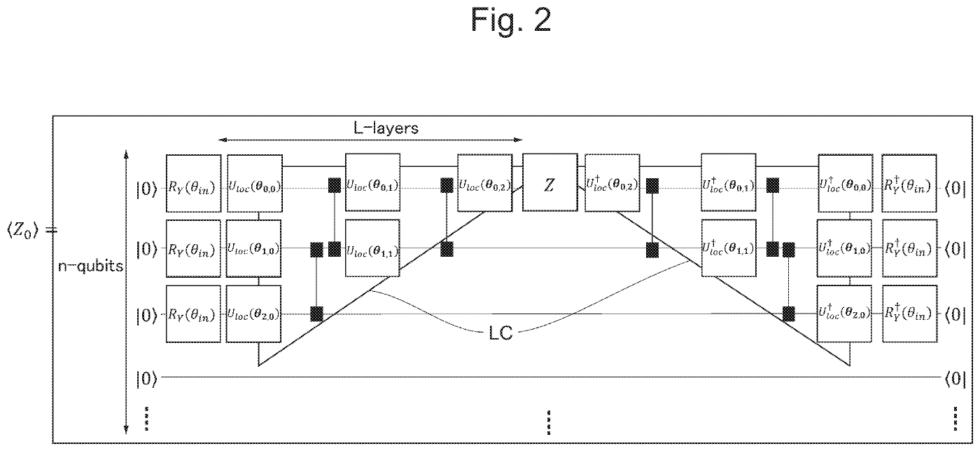

First, let the number of qubits (width) be n and the layer depth be L. Then, a shallow quantum circuit satisfying L+1<n is assumed. Here, in the case of an L-layer circuit, the circuit does not depend on the number of qubits n, and only L+1 qubits are involved. This is due to the locality and uniqueness of the HEA quantum circuit, specifically, due to the restrictions on the light cone LC of the tensor network, as illustrated in FIG. 2. In the HEA quantum circuit in the case where the entangled gates are short-range control Z gates (CZ gates), all one-bit gates are canceled out due to unitarity in the region not covered by the light cone. In addition, outside the light cone, all CZ gates are canceled out. Due to these properties, in the L-layer circuit, only L+1 qubits are involved in the calculation, and the calculation is independent of the number of qubits.

### Step 2

Under the above assumptions, the following equation is obtained as a density matrix in a valid input state.

$${ρ}_{in} ( {θ}_{in} ) = {( \frac{1}{2} ( 1 + sin {θ}_{in} X + cos {θ}_{in} Z ) )}^{⊗ ( L + 1 )} \qquad [ Math . 7 ]$$

### Step 3

By inference, d_{VC}≤2(L+1)+1 (or [symbol] Z₀ [symbol] , which is a trivial zero matrix), is derived.

### Step 4

Furthermore, considering the case of a deep quantum circuit, d_{VC}≤2 min (n, L+1)+1 is obtained, due to also depending on n. This boundary is for a case of short-range two-qubit entangled gates. It is also assumed that the data is one-dimensional, and the input encoding gate needs to be the same Ry(θᵢₙ(x)) for all qubits. In addition, the gate U_{loc}(θ_{q,l}) containing the parameters is arbitrary. Furthermore, these boundaries are for the open boundary condition (OBC), while, for the periodic boundary condition, d_{VC}≤2 min (n, 2L+1)+1 is obtained. In the case of a long-range qubit-entangled gate, only d_{VC}≤2n+1 is obtained.

Subsequently, description is made on the calculation process of the VC dimension in the case where the feature space is high-dimensional. Specifically, the VC dimension is able to be calculated by a computer executing the following calculation process (steps).

### Step 1

First, the following (1) to (4) are assumed:

(1) The dimension of the feature space is d. For simplicity, assume n≥d, n mod d=0.
(2) The input gate is assumed to be Ry only. For each qubit, only one feature xᵢ is encoded as Ry(θᵢₙ(xᵢ)), like x₀, . . . , x_{d-1}, x₀, . . . , x_{d-1}, and so on.
(3) The respective features are encoded into the same number of qubits (n/d).
(4) The following function f ( [symbol] Zᵢ [symbol] ) is defined as a threshold value. f( [symbol] Zᵢ [symbol] ) is a linear combination of [symbol] Z₁ [symbol] and yᵢ is a real number.

$$f ( 〈 {Z}_{i} 〉 ) = {\sum }_{i = 0}^{d - 1} {y}_{i} 〈 {Z}_{i} 〉 \qquad [ Math . 8 ]$$

### Step 2

Under the above assumptions, the function f is a d-dimensional real trigonometric polynomial, and therefore the degree of each dimension is at most (n/d) and the total number of linearly independent vectors is at most (2(n/d)+1)^{d}.

### Step 3

From the above, the VC dimension upper bound is calculated to be d_{VC}≤(2(n/d)+1)^{d}.

### Step 4

Furthermore, the upper bound is calculated with consideration of light cone restrictions. Specifically, under the assumption of the iterative encoding scheme, the following equation is obtained as a density matrix:

$${ρ}_{in} ( {θ}_{in} ) = {\prod }_{i = 0}^{\frac{n}{d} - 1} {\prod }_{j = 0}^{d - 1} ( \frac{1}{2} ( {1}_{j + dl} + sin [ {θ}_{in} ( {x}_{j} ) ] {X}_{j + dl} + cos [ {θ}_{in} ( {x}_{j} ) ] {Z}_{j + dl} ) ) \qquad [ Math . 9 ]$$

### Step 5

By inference, the following upper bound is derived in the case of a one-dimensional periodic boundary condition:

$${d}_{VC} \leq {( 2 min ( \frac{n}{d} , ⌊ \frac{2 L + 1}{d} ⌋ + 1 ) + 1 )}^{d} \qquad [ Math . 10 ]$$

### Step 6

Furthermore, in the case of Ry and Rz gate inputs, the following equation is obtained as the density matrix:

$${ρ}_{in} ( {θ}_{in} , {ϕ}_{in} ) = {\prod }_{i = 0}^{\frac{n}{d} - 1} {\prod }_{j = 0}^{d - 1} ( \frac{1}{2} {( \begin{matrix}1 + cos {θ}_{in} ( {x}_{j} ) & {e}^{\text{?}} sin {θ}_{in} ( {x}_{j} ) \\ {e}^{\text{?}} sin {θ}_{in} ( {x}_{j} ) & 1 - cos {θ}_{in} ( {x}_{j} )\end{matrix} )}_{j + dl} ) \qquad [ Math . 11 ]$$

$$\text{?} \text{indicates text missing or illegible when filed}$$

This gives a trigonometric polynomial in two-dimensional variables with the same highest degree. As a result, the upper bound for a general case is expressed by the following formula:

$${d}_{VC} \leq {( 2 ( \frac{n}{d} ) + 1 )}^{2 d} \qquad [ Math . 12 ]$$

The upper bound for a case of the one-dimensional periodic boundary condition is expressed by the following formula:

$${d}_{VC} \leq {( 2 min ( \frac{n}{d} , ⌊ \frac{2 L + 1}{d} ⌋ + 1 ) + 1 )}^{d} \qquad [ Math . 13 ]$$

The VC dimension lower bound 2≤d_{VC} in the HEA quantum circuit is obtained by using the calculation for a result of only the Ry gate with one qubit. Specifically, the VC dimension lower bound is able to be calculated by a computer executing steps 1 to 3 of the following calculation process.

### Step 1

θ_{q,l} is selected so that the zero-th qubit in the zero-th layer is Ry(θ) and all other 1-bit quantum gates are identity operators.

### Step 2

Simplification is possible to a case of one qubit in zero layer (L=0, n=1), and the lower bound is 2≤d_{VC}.

### Step 3

In the case of d dimension, data on the first feature axis x=(x₀, 0, . . . , 0) is considered.

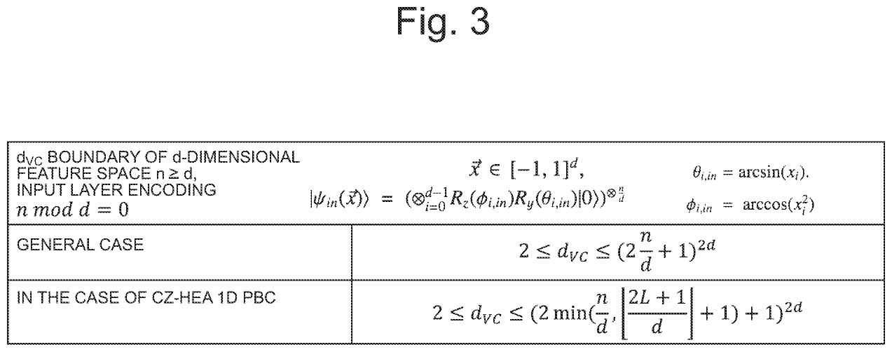

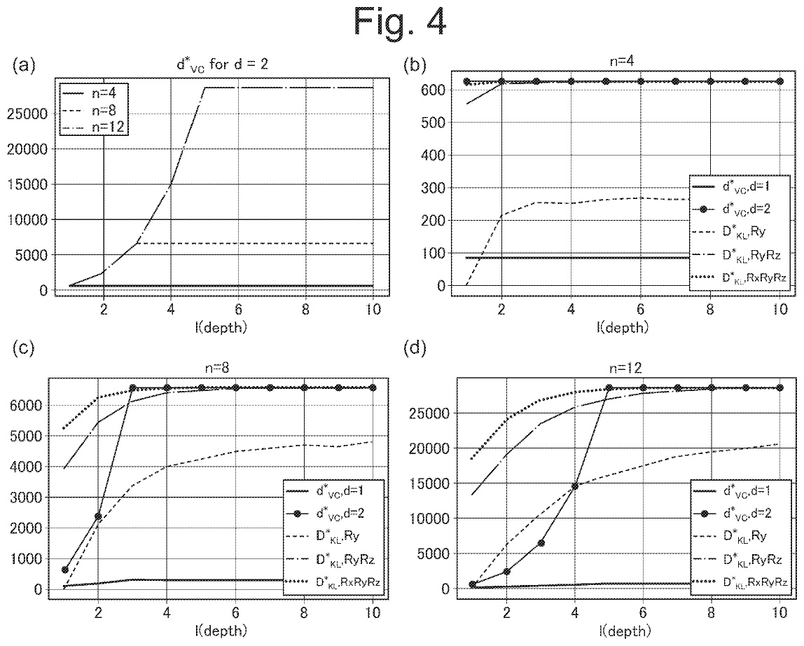

From the above, the VC dimension boundary in a quantum circuit is able to be summarized as illustrated in FIG. 3. FIG. 4 is a diagram illustrating the saturation degree of the VC dimension upper bound (d*_{VC}) and the saturation degree of the expressibility (D*_{KL}: hereinafter, KL expressibility) of the learning model for calculating the Kullback-Leibler (KL) divergence, with respect to the depth of the circuit. The VC dimension upper bound (d*_{VC}) is calculated from the formula (CZ-HEA 1D PBC) illustrated in FIG. 3.

FIG. 4(a) is a diagram illustrating d*_{VC} for cases where the number of qubits n is 4, 8, and 12. FIGS. 4(b) to 4(d) are diagrams in which d*_{VC} and D*_{KL} are compared with each other in the cases where n is 4, 8, and 12, respectively. In FIGS. 4(b) to 4(d), D*_{KL} is rescaled by the following formula for the sake of comparison:

$${D}_{KL}^{*} = {d}_{VC}^{*} ( \frac{{D}_{KL}^{max} - {D}_{KL}}{{D}_{KL}^{max} - {D}_{KL}^{min}} ) \qquad [ Math . 14 ]$$

It is apparent from FIGS. 4(b) to 4(d) that the way of saturation of rescaled D*_{KL} is similar to that of the VC dimension upper bound d*_{VC}. This indicates that the VC dimension may be a complementary scale of the model complexity.

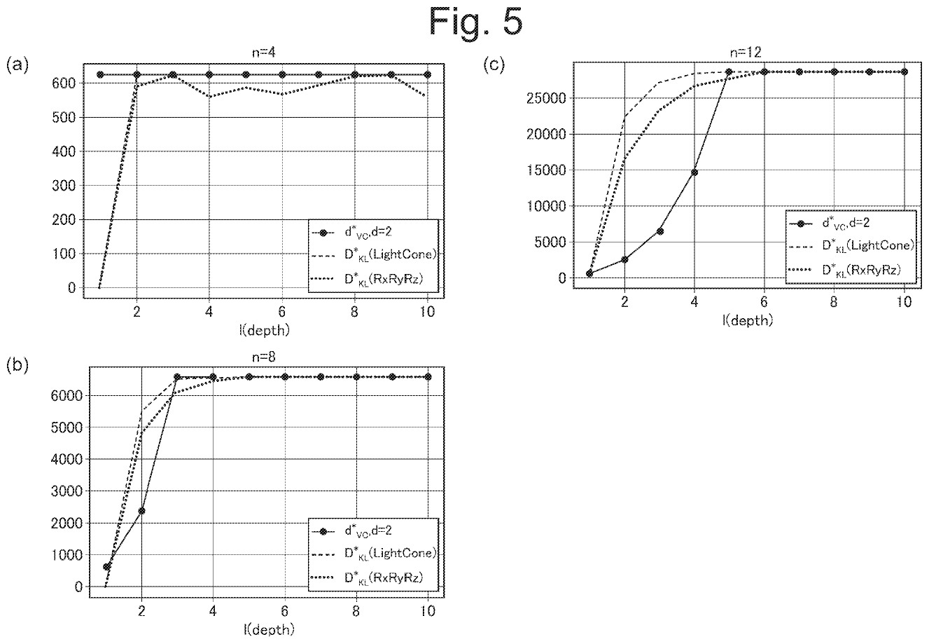

In addition, FIG. 5 is a diagram illustrating a comparison between the KL expressibility D*_{KL} and d*_{VC} in the case of considering the light cone restrictions as illustrated in FIG. 2. FIGS. 5(a) to 5(c) illustrate examples for the cases where the number of qubits n is 4, 8, and 12, respectively.

### Suppression of Overfilling

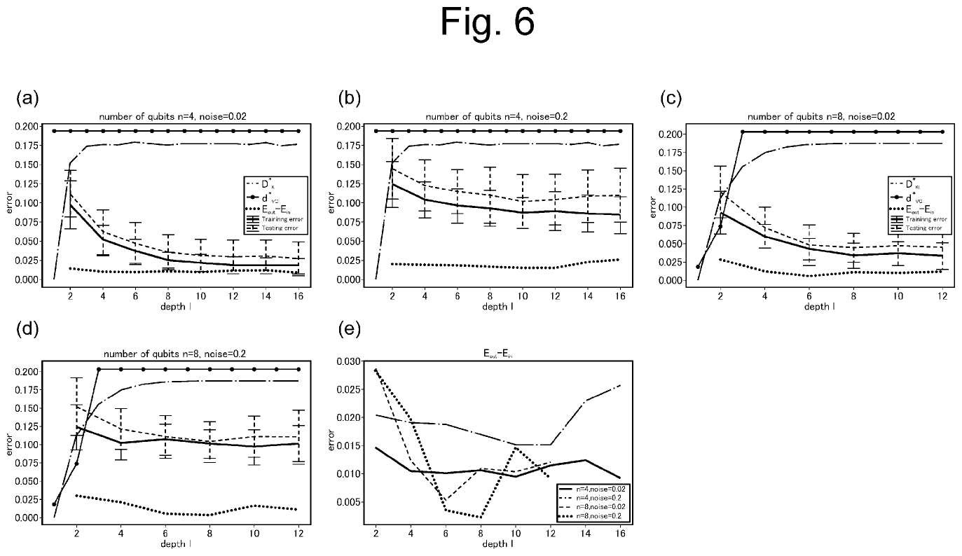

FIG. 6 is a diagram illustrating a relationship between the VC dimension upper bound d*_{VC}, the KL expressibility D*_{KL}, a training error, a testing error, and a generalization error (Eₒᵤₜ−Eᵢₙ). FIGS. 6(a) and 6(b) illustrate cases where the number of qubits n is 4, and FIGS. 6(c) and 6(d) illustrate cases where the number of qubits n is 8. FIG. 6(e) illustrates the generalization errors (Eₒᵤₜ−Eᵢₙ) in FIGS. 6(a) to 6(d). The larger the generalization error is, the larger the degree of overfitting is. FIG. 6 indicates that overfitting is suppressed when the VC dimension upper bound d*_{VC} and the KL expressibility D*_{KL} are saturated.

As described above, according to the present embodiment, the VC dimension boundary of the quantum circuit is able to be identified on the basis of the depth L (the number of steps) and the width n (the number of qubits) of the quantum circuit. Furthermore, it is confirmed that overfitting in the quantum learning circuit is unlikely to occur due to the saturation of the VC dimension upper bound. This makes it possible to quantitatively indicate that the quantum circuit is a model that prevents overfitting in machine learning.

### Hardware Configuration

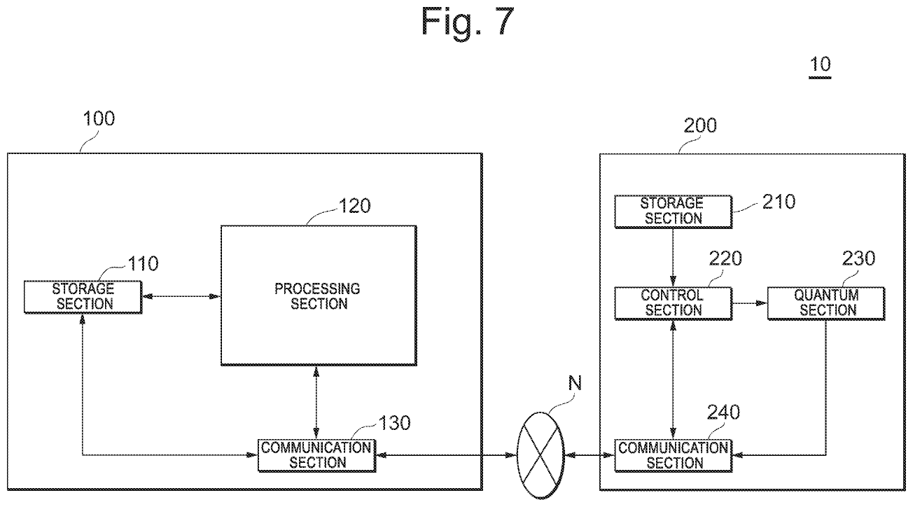

FIG. 7 is a diagram illustrating an example configuration of a computer system 10 that implements the quantum circuit according to the present invention. The computer system 10 includes a classical computer 100 and a quantum computer 200. Therefore, the computer system 10 is configured as a hybrid system having both classical computer and quantum computer functions. The classical computer 100 and the quantum computer 200 are communicatively connected via a communication network N. The communication network N is a wired or wireless communication network, which may be, for example, the Internet, or a local area network (LAN) and the like.

The classical computer 100 performs various information processes by executing classical programs. A classical program is a code expressing an algorithm able to be executed by the classical computer. The classical program is a program written in a programming language such as C, for example. The classical computer 100 has a storage section 110, a processing section 120, and a communication section 130.

The storage section 110 stores various kinds of information. Specifically, the storage section 110 stores classical programs for the processing section 120 to execute various processes, information to be processed by the processing section 120, results of the processes executed by the processing section 120, and data or other information generated by the quantum computer 200. The various kinds of information stored in the storage section 110 is referred to by the processing section 120 as needed.

The processing section 120 has a function to process various kinds of information. In addition, the processing section 120 is able to store the results of the processes in the storage section 110.

The communication section 130 is able to send and receive various kinds of information. The communication section 130 is able to send data generated by the processing section 120 to the quantum computer 200. Furthermore, the communication section 130 is able to receive the results of execution of the quantum computation algorithm by the quantum computer 200. In addition, the communication section 130 is able to store the received information in the storage section 110.

The quantum computer 200 is a computer that performs calculations by using quantum mechanical phenomena of matter, and may be a quantum gate type quantum computer. The quantum computer 200 may be composed of any hardware.

The quantum computer 200 is able to execute quantum computation algorithms based on quantum programs. The quantum programs are codes expressing various quantum algorithms. The quantum program may be represented, for example, as a quantum circuit according to the present invention. The quantum programs may include programs written in programming languages as well as classical programs.

The quantum computer 200 has a storage section 210, a control section 220, a quantum section 230, and a communication section 240. The storage section 210, the control section 220, and the communication section 240 may include classical computer functions.

The storage section 210 stores various kinds of information. For example, the storage section 210 stores the quantum program used for the quantum section 230 to execute a quantum computation algorithm. Various kinds of information stored in the storage section 210 is referred to by the control section 220 as needed.

The control section 220 is able to control the quantum section 230 on the basis of the quantum program. Specifically, the control section 220 is able to cause the quantum section 230 to execute the quantum computation algorithm based on the parameters generated by the processing section 120 and on the feature data corresponding to the input data.

The quantum section 230, which is the core part of the quantum computer 200, is able to execute the quantum computation algorithm under the control of the control section 220.

The communication section 240 has a function of sending and receiving various kinds of information. For example, the communication section 240 sends the results of execution by the quantum section 230 to the classical computer 10.

The present invention is not limited to the above-described embodiments, but may be implemented in various other forms within the scope not departing from the gist of the invention. For this reason, the above embodiments are in all respects merely illustrative and are not to be construed as limiting.

### Reference Signs List

11 Initial state

12 Ry gate

13 Rz gate

14 Input state ψᵢₙ

15 Single-qubit rotation gate layer U(θ)

16 Entangled gate layer Uₑₙₜ

17 Output state ψₒᵤₜ

10 Computer system

100 Classical computer

110 Storage section

120 Processing section

130 Communication section

200 Quantum computer

210 Storage section

220 Control section

230 Quantum section

240 Communication section

1. A method for calculating a VC dimension boundary in a quantum circuit comprising:
a step in which a computer acquires a depth L of the quantum circuit;
a step in which the computer acquires a width n of the quantum circuit; and
a step in which the computer identifies the VC dimension boundary in the quantum circuit on the basis of the depth L and the width n.

2. The method for calculating the VC dimension boundary in the quantum circuit according to claim 1, wherein the depth L is the number of steps in calculation and the width n is the number of qubits.

3. The method for calculating the VC dimension boundary in the quantum circuit according to claim 1, wherein, assuming that d is the dimension of a feature space, the boundary of the VC dimension d_{VC} is identified by the following formula (1):
$$\begin{matrix}[ Math . 15 ] & \\ 2 \leq {d}_{VC} \leq {( 2 \frac{n}{d} + 1 )}^{2 d} & ( 1 )\end{matrix}$$

4. The method for calculating the VC dimension boundary in the quantum circuit according to claim 1, wherein:
the quantum circuit is an HEA quantum circuit; and
assuming that d is the dimension of the feature space and in the case where a periodic boundary condition of the quantum circuit is one-dimensional, the boundary of the VC dimension d_{VC} is identified by the following formula (2):
$$\begin{matrix}[ Math . 16 ] & \\ 2 \leq {d}_{VC} \leq {( 2 min ( \frac{n}{d} , ⌊ \frac{2 L + 1}{d} ⌋ + 1 ) + 1 )}^{d} & ( 2 )\end{matrix}$$

5. The method for calculating the VC dimension boundary in the quantum circuit according to claim 1, further comprising a step of acquiring an upper bound of a generalization error in learning by the quantum circuit on the basis of the upper bound of the identified VC dimension d_{VC}.

6. A program causing a computer to execute:
a step of acquiring a depth L of a quantum circuit;
a step of acquiring a width n of the quantum circuit; and
a step of identifying the VC dimension boundary in the quantum circuit on the basis of the depth L and the width n.
